(19) United States
(12) Patent Application Publication
(10) Pub. No.: US 2026/0339067 A1
(43) Pub. Date: Oct. 29, 2026

(54) REFLECTIVE MODULE

(71) Applicant: SAMSUNG ELECTRO-MECHANICS CO., LTD., Suwon-si (KR)

(72) Inventors: Jong Woo HONG, Suwon-si (KR); Young Hwan KWON, Suwon-si (KR)

(73) Assignee: SAMSUNG ELECTRO-MECHANICS CO., LTD., Suwon-si (KR)

(21) Appl. No.: 19/455,479

(22) Filed: Jan. 21, 2026

(30) Foreign Application Priority Data
Apr. 23, 2025 (KR) 10-2025-0053171

(51) Int. Cl. G02B 7/182

(52) U.S. Cl. CPC G02B 7/1827

(57) ABSTRACT

A reflective module includes a rotational carrier supported on a housing in a first direction, the rotational carrier being rotatable with respect to the housing; a reflective holder supported on the rotational carrier in a second direction, different from the first direction, the reflective holder being rotatable with respect to the rotational carrier; and a reflective member coupled to the reflective holder. A first sensing magnet disposed on the rotational carrier and a second sensing magnet disposed on the reflective holder face the housing in a third direction perpendicular to both the first direction and the second direction.

### CROSS-REFERENCE TO RELATED APPLICATIONS

This application claims benefit of priority to Korean Patent Application No. 10-2025-0053171 filed on Apr. 23, 2025, in the Korean Intellectual Property Office, the entire disclosure of which is incorporated herein by reference for all purposes.

### BACKGROUND

### 1. Field

The present disclosure relates to a reflective module.

### 2. Description of the Background

Camera modules are adopted for use in portable electronic devices, including smartphones. Folded cameras, in particular, are equipped with reflective modules including reflective members.

When external magnetic devices, such as vibration motors, are installed in portable electronic devices, including smartphones, an external magnetic field may affect the operation of internal components, such as sensors, coils, and magnets, causing magnetic interference problems.

The magnetic interference problem may lead to issues, such as focusing errors in camera modules or reduced image stabilization performance.

As a result, the installation of external magnetic devices is limited.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reflective module includes a rotational carrier supported on a housing in a first direction, the rotational carrier being rotatable with respect to the housing; a reflective holder supported on the rotational carrier in a second direction, different from the first direction, the reflective holder being rotatable with respect to the rotational carrier; and a reflective member coupled to the reflective holder. A first sensing magnet disposed on the rotational carrier and a second sensing magnet disposed on the reflective holder face the housing in a third direction perpendicular to both the first direction and the second direction.

The reflective module may further include first and second magnetic members configured to provide magnetic force so that the reflective holder is supported on the rotational carrier. The first magnetic member may be disposed on either one of the reflective holder or the rotational carrier, and the second magnetic member may be disposed on another of the reflective holder or the rotational carrier.

Either one or both of the first magnetic member and the second magnetic member may be pulling magnets.

The first sensing magnet may face a first position sensor disposed in the housing, and the second sensing magnet may face a second position sensor disposed in the housing.

A first ball member, disposed between the rotational carrier and the housing, may form a rotational axis of the rotational carrier. A support portion, disposed between the reflective holder and the rotational carrier, may form a rotational axis of the reflective holder and include a plurality of second ball members.

The reflective module may further include one or more accommodation recesses arranged in either one or both of the reflective holder and the rotational carrier. The one or more accommodation recesses may be configured to accommodate the support portion in the second direction.

The rotational axis of the reflective holder may pass through the support portion.

The support portion forming the rotational axis of the reflective holder may further include one or more support protrusions.

The reflective module may further include a first accommodation recess disposed in either one or both of the housing and the rotational carrier. The first accommodation recess may be configured to support the first ball member at three or more contact points.

The reflective module may further include a plurality of guide ball members configured to guide rotation of the rotational carrier. The plurality of guide ball members may be movable in a direction perpendicular to the first direction with respect to the first ball member.

The reflective module may further include a first driving magnet disposed on a surface of the rotational carrier facing the housing in the third direction. The first driving magnet may be configured to provide driving force to rotate the rotational carrier.

The reflective module may further include a second driving magnet disposed on a surface of the reflective holder facing the housing in the third direction. The first driving magnet may be configured to provide driving force to rotate the reflective holder.

The first sensing magnet and the second sensing magnet may face the housing in the third direction.

In another general aspect, a reflective module includes a rotational carrier rotatable about a first rotational axis; a reflective holder disposed on the rotational carrier, the reflective holder being rotatable about a second rotational axis perpendicular to the first rotational axis; and a reflective member coupled to the reflective holder. A first sensing magnet is disposed on the rotational carrier, a second sensing magnet is disposed on the reflective holder, a first driving magnet is disposed parallel to the first sensing magnet on the rotational carrier, and a second driving magnet is disposed parallel to the second sensing magnet on the reflective holder.

The reflective module may further include a housing. The rotational carrier may be supported by the housing in a first direction, parallel to the first rotational axis, by first magnetic force. The reflective holder may be supported by the rotational carrier in a second direction, perpendicular to the first direction, by second magnetic force.

The first magnetic force may be generated by a third magnetic member disposed in one of the housing and the rotational carrier, and a fourth magnetic member disposed in another of the housing and the rotational carrier. Either one or both of the third magnetic member and the fourth magnetic member may be pulling magnets.

The second magnetic force may be generated by a first magnetic member disposed on one of the rotational carrier and the reflective holder, and a second magnetic member disposed on the other of the rotational carrier and the reflective holder. Either one or both of the first magnetic member and the second magnetic member may be pulling magnets.

The reflective module may further include a housing. The first and second sensing magnets may be disposed to face a surface of the housing on an imaginary line extending through the second rotational axis.

The first sensing magnet may face a first position sensor disposed in the housing, and the second sensing magnet may face the second position sensor disposed in the housing.

The reflective module may further include a first ball member, disposed between the rotational carrier and the housing, forming the first rotational axis. A support portion, disposed between the reflective holder and the rotational carrier, may form the second rotational axis, and include one or more second ball members.

Polarity directions of the first sensing magnet and the first driving magnet may be the same, and polarity directions of the second sensing magnet and the second driving magnet may be the same.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of a camera module according to an embodiment of the present disclosure.

FIG. 3 is a perspective view of a reflective module according to an embodiment of the present disclosure.

FIG. 4 is an exploded perspective view of a reflective module according to an embodiment of the present disclosure.

FIG. 5 is an exploded perspective view of a reflective module viewed in another direction.

FIG. 6 is a partial cross-sectional view taken along line I-I’ of FIG. 3.

FIG. 7 is a partial cross-sectional view taken along line II-II’ of FIG. 3.

FIG. 8 is a right side view of a reflective module according to an embodiment of the present disclosure.

FIG. 9 is a left side view of a reflective module according to an embodiment of the present disclosure.

FIG. 10 is a reference diagram illustrating coupling of a housing and a circuit board.

FIG. 11A and 11B are reference diagrams illustrating positions of a driving coil and a position sensor.

FIG. 12 is a perspective view of a reflective module according to another embodiment of the present disclosure.

FIG. 13 is a perspective view of a reflective module according to another embodiment of the present disclosure.

FIG. 14A and 14B are left and right side views of a reflective module according to another embodiment of the present disclosure.

FIG. 15A and 15B are reference diagrams illustrating a support portion according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to a reflective module, which is mounted on a camera module, and the camera module may be mounted on portable electronic devices, such as mobile communication terminals, smartphones, and tablet PCs.

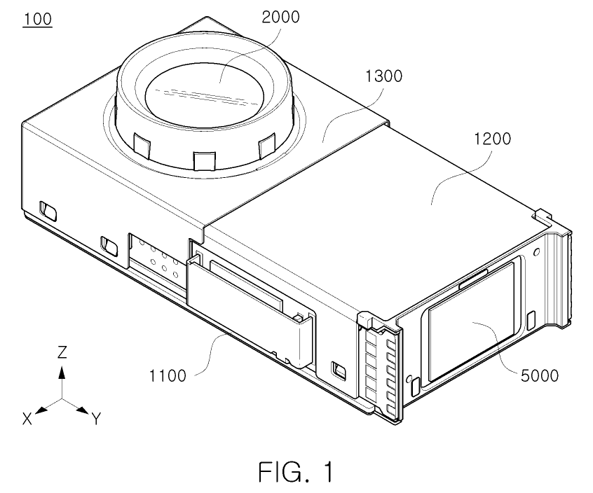

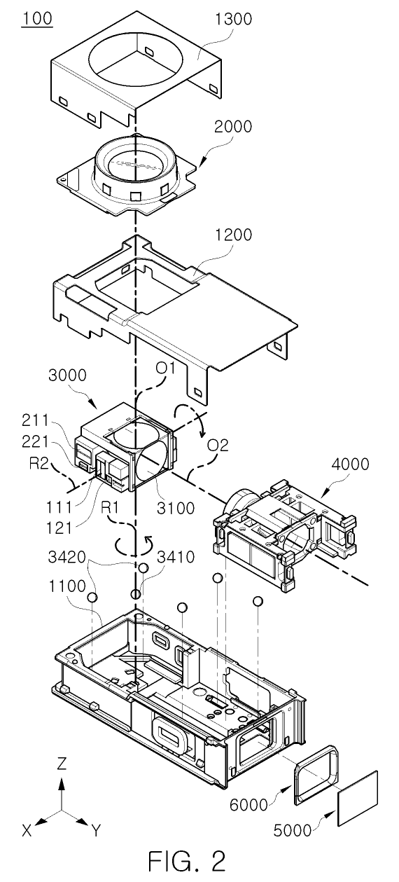

FIG. 1 is a perspective view of a camera module 100 according to an embodiment of the present disclosure, and FIG. 2 is an exploded perspective view of the camera module 100 according to an embodiment of the present disclosure.

Referring to FIGS. 1 and 2, the camera module 100 according to an embodiment of the present disclosure may include at least one lens module and a housing 1100.

The camera module 100 may include at least one lens module. In an embodiment, the at least one lens module may include a first lens module 2000. In another embodiment, the at least one lens module may further include a second lens module 4000 in addition to the first lens module 2000. Light incident on the camera module 100 from an external subject may pass through the first lens module 2000 and the second lens module 4000 to be incident on the image sensor 5000.

The first lens module 2000 may have a first optical axis, and the second lens module 4000 may have a second optical axis.

The first and second optical axes may not be parallel. For example, the first lens module 2000 and the second lens module 4000 may be arranged so that the first and second optical axes intersect. The first and second optical axes may be approximately perpendicular, but the angle therebetween is not limited thereto.

The lenses included in at least one of the first lens module 2000 and the second lens module 4000 may be configured to be movable with respect to the image sensor 5000. For example, the lenses included in the first lens module 2000 may be configured to move along the first optical axis. In another embodiment, the lenses included in the second lens module 4000 may be configured to move along the second optical axis. As the lenses included in each lens module move, an optical image stabilization (OIS) or autofocus (AF) function of the camera module 100 may be performed. For example, the camera module 100 may perform the autofocus function by moving the lenses of the second lens module 4000 in the second optical axis direction.

The lenses included in at least one of the first lens module 2000 and the second lens module 4000 may be fixed in position with respect to the housing 1100. For example, in the camera module 100, the lens included in the first lens module 2000 may be fixed with respect to the housing 1100, and the lens included in the second lens module 4000 may be configured to be movable in the second optical axis direction.

In the camera module 100, a reflective module 3000 may be disposed to change a traveling direction of light emitted from the first lens module 2000 to a direction parallel to the second optical axis. For example, referring to FIG. 2, the reflective module 3000, which changes the traveling path of light, may be disposed between the first lens module 2000 and the second lens module 4000. That is, the camera module 100 may include the reflective module 3000 disposed on an optical path from the first lens module 2000 to the second lens module 4000.

The reflective module 3000 may be accommodated within an internal space of the housing 1100 and may change the path of light incident on the reflective module 3000. Here, the reflective module 3000 may be understood as including at least some of a reflective member 3100 changing the path of light, components supporting and driving the reflective member 3100, and the housing 1100 accommodating these components.

The reflective member 3100 of the reflective module 3000 may be configured to change the path of light by refracting or reflecting light. For example, the reflective member 3100 of the reflective module 3000 may be a prism or mirror changing an optical path by refracting or reflecting light.

The reflective member 3100 may change the path of light emitted from the first lens module 2000 so as to be directed toward the second lens module 4000. For example, the reflective member 3100 may change the traveling path of light incident along the first optical axis to a direction approximately parallel to the second optical axis.

The reflective member 3100 may be configured to be rotatable or movable within the housing 1100. Depending on the rotation or movement of the reflective member 3100, the optical path may be appropriately changed. The camera module 100 may perform an optical image stabilization (OIS) function by rotating or moving the reflective member 3100.

The reflective member 3100 may be configured to have a plurality of rotational axes and be rotatable in different directions. For example, the reflective member 3100 may rotate about a first rotational axis, parallel to the first optical axis, or the reflective member 3100 may rotate about a second rotational axis, perpendicular to both the first and second optical axes. When the reflective member 3100 rotates about the second rotational axis, a reflective surface 3130 of the reflective member 3100 may be tilted, thereby changing the traveling path of light to be approximately parallel to the second optical axis.

In the following description, a direction, parallel to the first optical axis, may be referred to as a “first direction,” a direction, parallel to the second optical axis, may be referred to as a “second direction,” and a direction, perpendicular to both the first and second optical axes, may be referred to as a “third direction.”

The camera module 100 may include the reflective module 3000 and the image sensor 5000 on which light passing through a plurality of lens modules is incident. The image sensor 5000 may convert the incident light into image information. The image sensor 5000 may be disposed such that a light collection surface thereof faces an exit surface of the second lens module 4000 and may generate an electrical signal corresponding to light incident from the second lens module 4000.

The image sensor 5000 may be accommodated within the housing 1100 or may be disposed outside the housing 1100.

A filter unit 6000 may be disposed in front of the image sensor 5000 to filter at least a portion of the light incident from the lens module. The filter unit 6000 may include an optical filter capable of blocking light of a specific wavelength.

The housing 1100 may have an internal space capable of accommodating at least one of the reflective module 3000, a plurality of lens modules, or the image sensor 5000. The housing 1100 may be formed of a material having a predetermined rigidity to protect the components accommodated therein. The housing 1100 may be a box-shaped member with an open top. However, the material and shape of the housing 1100 are not limited thereto.

The camera module 100 may include a shield can 1200 covering an upper portion of the housing 1100. The shield can 1200 may cover the open upper portion of the housing 1100 to protect components inside the housing 1100 from the external environment.

In the camera module 100 according to the embodiment, some of the plurality of lens modules may be disposed outside the housing 1100, while others may be disposed inside the housing 1100. For example, as illustrated in FIG. 1 or FIG. 2, the first lens module 2000 may be coupled to an outer portion of the housing 1100 and disposed above the reflective module 3000, while the second lens module 4000 may be disposed inside the housing 1100. In this case, the exit surface 3120 of the lens included in the first lens module 2000 may be disposed to face an incident surface 3110 of the reflective member 3100 included in the reflective module 3000.

When some lens modules are disposed outside the housing 1100, the camera module 100 may further include a component for structural or optical stability of the lens modules disposed outside the housing 1100. For example, the camera module 100 may further include a cover 1300 capable of shielding a space between the first lens module 2000 and the housing 1100.

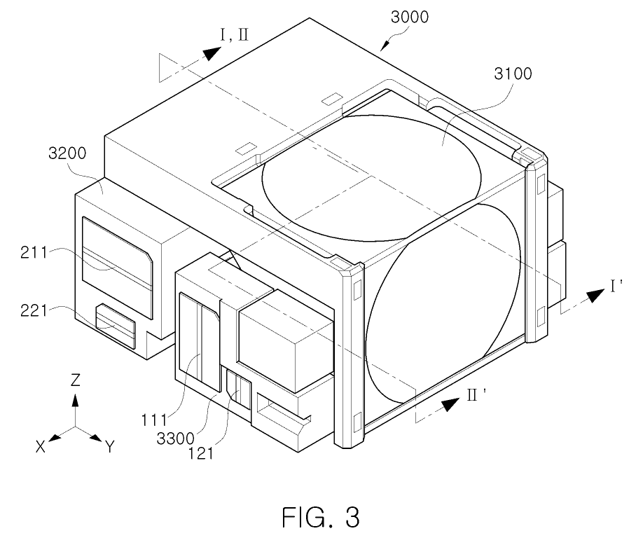

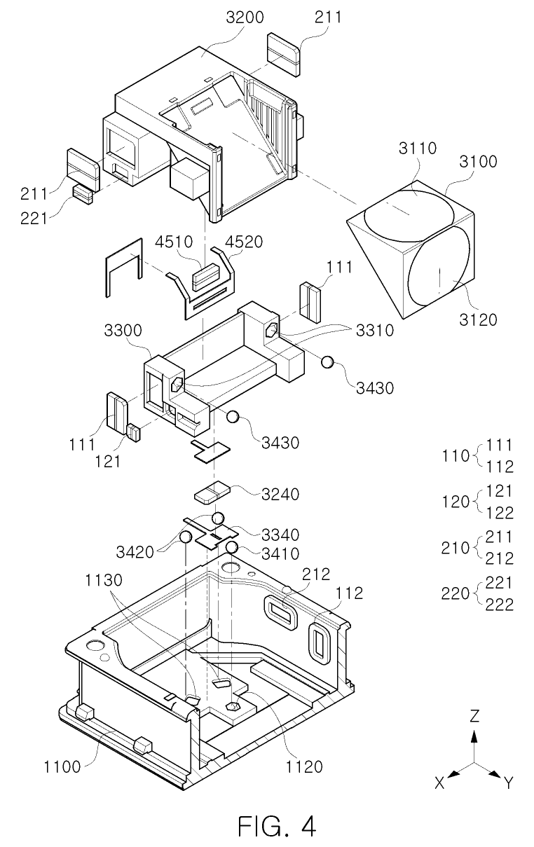

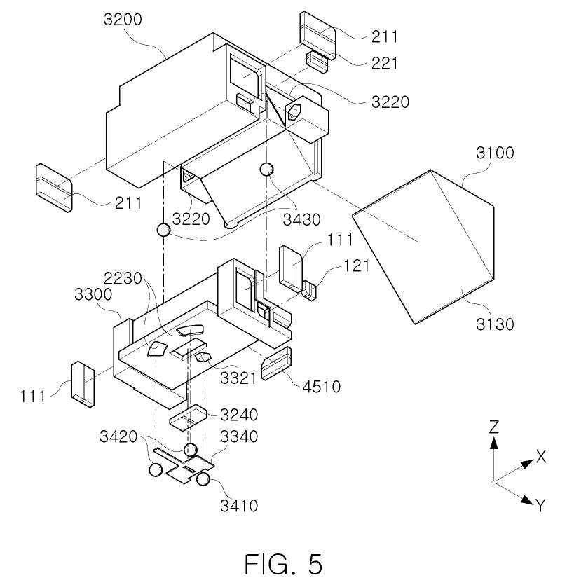

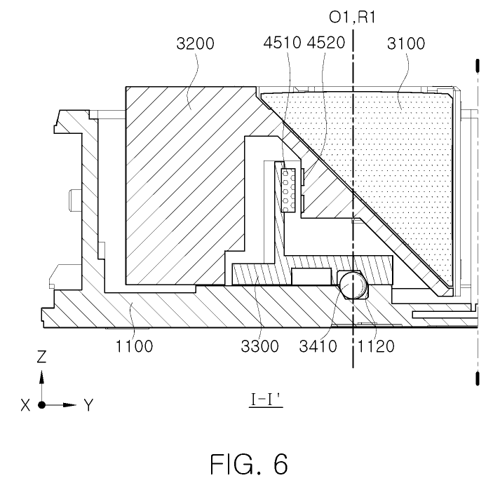

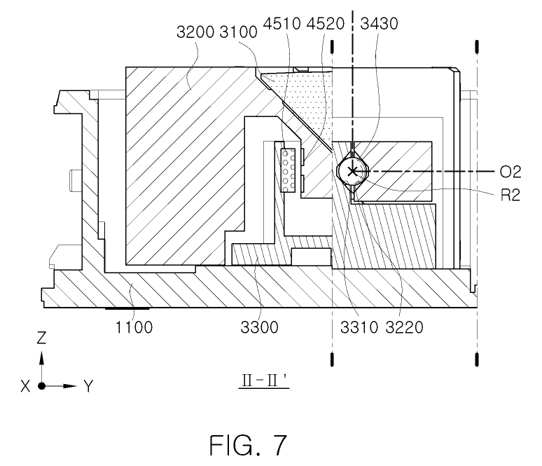

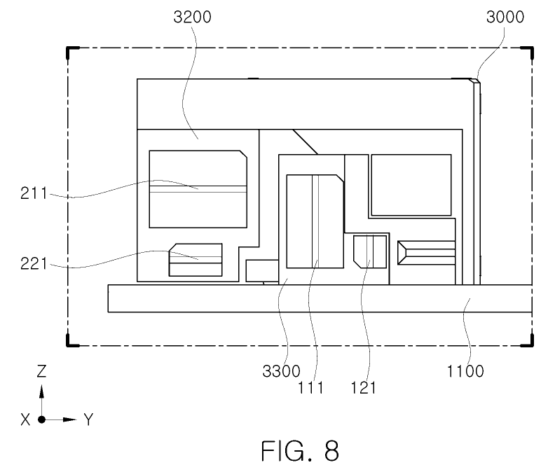

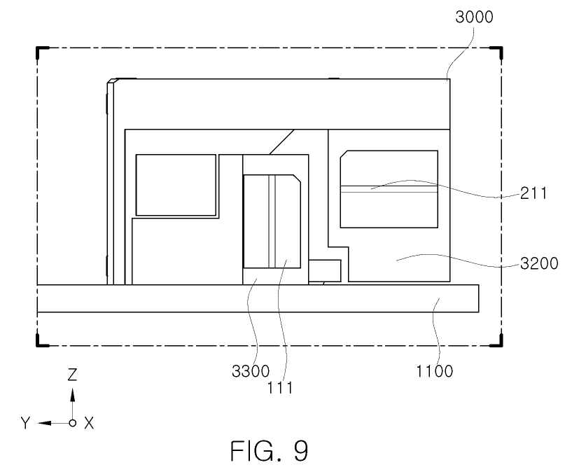

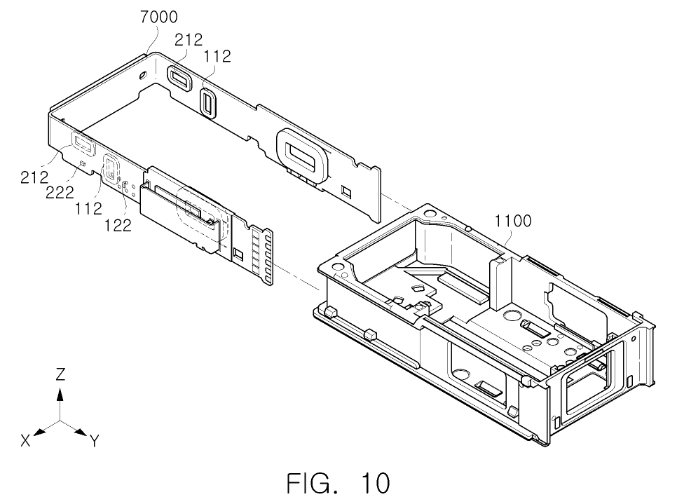

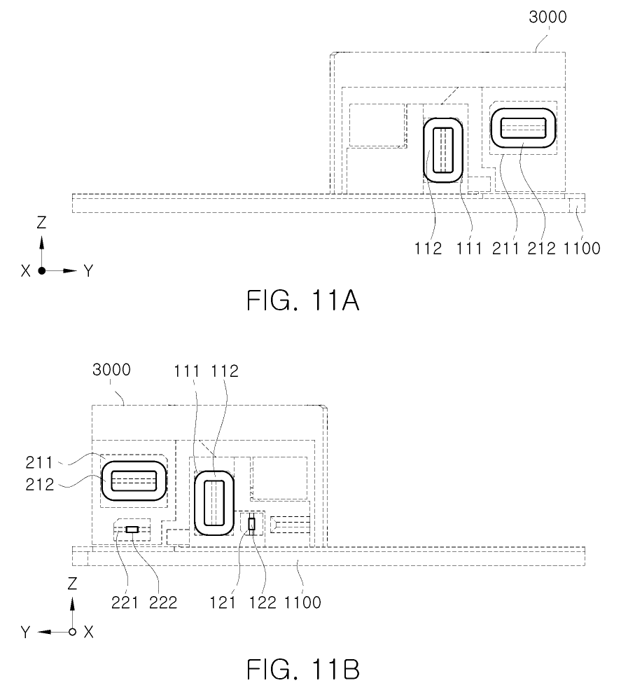

Hereinafter, the reflective module 3000 will be described in detail with reference to FIGS. 3 - 11B. FIG. 3 is a perspective view of the reflective module 3000. FIG. 4 is an exploded perspective view of the reflective module 3000. FIG. 5 is an exploded perspective view of the reflective module 3000 viewed in another direction. FIG. 6 is a partial cross-sectional view taken along line I-I’ of FIG. 3. FIG. 7 is a partial cross-sectional view taken along line II-II’ of FIG. 3. FIG. 8 is a right side view of the reflective module 3000. FIG. 9 is a left-side view of the reflective module 3000. FIG. 10 is a reference diagram related to the coupling of the housing 1100 and the circuit board 7000. FIG. 11A and 11B are reference diagrams related to positions of a driving coil and a position sensor. The reflective module 3000 described with reference to FIGS. 3 - 11B corresponds to the reflective module 3000 described above, and thus, a redundant description may be omitted.

Referring to FIG. 3, the reflective module 3000 may be accommodated within the housing 1100 and may include the reflective member 3100 capable of changing an optical path. The reflective member 3100 may include the incident surface 3110 through which light may enter from the first lens module 2000 and the exit surface 3120 through which light may be emitted.

The reflective member 3100 may be configured to be movable within the housing 1100. For example, the reflective member 3100 may rotate about different rotational axes.

The reflective module 3000 may include the reflective member 3100 capable of changing the optical path, a reflective holder 3200 flexibly supporting the reflective member 3100, and a rotational carrier 3300.

The reflective member 3100 may change the traveling path of light by refracting or reflecting incident light.

The reflective member 3100 may include the incident surface 3110 on which light is incident, the reflective surface 3130 from which light is reflected, and the exit surface 3120 from which the reflected light is emitted. For example, light incident on the incident surface 3110 in the first direction may be reflected from the reflective surface 3130 and emitted in the second direction. Here, the first direction may be approximately parallel to the first optical axis of the first lens module 2000, and the second direction may be approximately parallel to the second optical axis of the second lens module 4000.

The reflective member 3100 may be provided on the reflective holder 3200. The reflective holder 3200 may support, rotate, or move the reflective member 3100. For example, the reflective holder 3200 may have a support portion 340 supported by the rotational carrier 3300 and may rotate about a second rotational axis passing through the support portion 340. Accordingly, the reflective member 3100 provided on the reflective holder 3200 may also rotate.

The reflective module 3000 may further include the rotational carrier 3300, movably or rotatably supporting the reflective holder 3200. The rotational carrier 3300 may be configured to rotatably support the reflective holder 3200 and simultaneously rotate or move with respect to the housing 1100. For example, the reflective holder 3200 may be rotatably supported on the rotational carrier 3300 with the support portion 340 forming a rotational axis interposed therebetween. In addition, the rotational carrier 3300 may be supported on the housing 1100 with at least one ball member, i.e., a first ball member 3410, interposed therebetween, and thus may rotate with respect to the housing 1100 about a first rotational axis formed by the first ball member 3410.

In the reflective module 3000 according to embodiments, the first and second rotational axes may be different from each other. For example, the first and second rotational axes may be approximately perpendicular.

The first rotational axis may pass through the incident surface 3110 and the reflective surface 3130 of the reflective member 3100. The second rotational axis may be approximately parallel to the reflective surface 3130 of the reflective member 3100. For example, the second rotational axis may be disposed on the reflective surface 3130 or parallel to the reflective surface 3130 at a predetermined distance.

In the reflective module 3000, the first and second rotational axes may be configured to intersect at a single point. Here, the point at which the first and second rotational axes intersect may be disposed on the reflective surface 3130 of the reflective member 3100 or adjacent to the reflective surface 3130.

When the incident surface 3110 of the reflective module 3000 and the upper surface of the housing 1100 are parallel, the incident surface 3110 of the reflective member 3100 may be approximately perpendicular to the first optical axis of the first lens module 2000, and the exit surface 3120 of the reflective member 3100 may be approximately perpendicular to the second optical axis of the second lens module 4000. In this case, the first rotational axis of the reflective module 3000 may be approximately identical to the first optical axis, and the second rotational axis of the reflective module 3000 may be perpendicular to both the first and second optical axes. Furthermore, similar to an intersection of the first and second rotational axes, an intersection of the first and second optical axes may be located on the reflective surface 3130 of the reflective member 3100.

Although the camera module 100 is shaken by external force, causing light to be incident in a direction deviating from the first optical axis, the reflective member 3100 may appropriately rotate to change the traveling direction of light to be approximately parallel to the second optical axis.

The reflective module 3000 may further include a support member allowing the reflective holder 3200 to be supported by the rotational carrier 3300. For example, the support member may be configured as a pair of magnetic members arranged to face each other and exerting magnetic force, and the reflective holder 3200 may be supported on the rotational carrier 3300 by magnetic attraction or repulsion generated by the pair of magnetic members.

The pair of magnetic members may be defined as first and second magnetic members 3240 and 3340 and may be separately arranged on the reflective holder 3200 and the rotational carrier 3300, respectively. For example, as illustrated in FIGS. 4 and 5, the first and second magnetic members 3240 and 3340 may include a pulling yoke disposed on the reflective holder 3200 and a pulling magnet arranged on the rotational carrier 3300. In this case, the pulling magnet and pulling yoke generate magnetic force attracting each other, and due to magnetic force, the reflective holder 3200 may be supported on the rotational carrier 3300 with the support portion 340 interposed therebetween.

However, the configuration of the first and second magnetic members 3240 and 3340 is not limited to those described above. For example, the pulling magnet and pulling yoke may be respectively disposed on the reflective holder 3200 and the rotational carrier 3300. Alternatively, both the first and second magnetic members 3240 and 3340 may be configured as magnets.

The support member is not limited to the magnetic member described above and may include any material capable of flexibly supporting the reflective holder 3200 on the rotational carrier 3300.

A sensing magnet may be provided on the reflective module 3000. A first sensing magnet 121 may be disposed on the rotational carrier 3300, and a second sensing magnet 221 may be disposed on the reflective holder 3200.

The first sensing magnet 121 may be disposed to alternately have N and S-poles in the second direction, and the second sensing magnet 221 may be disposed to alternately have N and S-poles in the first direction.

The first and second sensing magnets 121 and 221 may be disposed on the reflective module 3000 to face the housing 1100 along the third direction that is perpendicular to both the first and second directions, respectively, to improve external magnetic field interference.

The first and second sensing magnets 121 and 221 may be arranged so that one surface of the housing 1100 the first sensing magnet 121 faces in the third direction and one surface of the housing 1100 the second sensing magnet 221 faces in the third direction are the same.

Accordingly, there is no restriction in disposing an external magnetic device on the opposite side of a portion in which the first and second sensing magnets 121 and 221 are arranged in the third direction with respect to the reflective module 3000, thereby improving external magnetic interference.

Similarly, there is no restriction in arranging an external magnetic device on the opposite side of a portion in which the second lens module 4000 is disposed, in the second direction with respect to the reflective module 3000, thereby improving external magnetic interference.

Although the first and second sensing magnets 121 and 221 are arranged on the same surface of the reflective module 3000, the center of gravity of the reflective module 3000 may not change.

The first and second sensing magnets 121 and 221 may be disposed on the reflective module 3000 as a single unit, rather than a plurality of units.

In embodiments, the reflective module 3000 may include a driving magnet driving the reflective holder 3200 and the rotational carrier 3300. For example, as illustrated in FIG. 3, the reflective module 3000 may include a first driving magnet 111 driving the rotational carrier 3300 and a second driving magnet 211 driving the reflective holder 3200.

The first driving magnet 111 and the second driving magnet 211 may face the first driving coil 112 and the second driving coil 212 disposed in the housing 1100, respectively, and the rotational carrier 3300 may be rotated by the electromagnetic interaction between the first driving magnet 111 and the first driving coil 112. In addition, the reflective holder 3200 may be rotated by the electromagnetic interaction between the second driving magnet 211 and the second driving coil 212.

In the camera module 100, the driving magnet and the driving coil may be respectively disposed on components moving with respect to each other. For example, the first driving magnet 111 may be disposed on the rotational carrier 3300, and the first driving coil 112 may be disposed on the housing 1100. The second driving magnet 211 may be disposed on the reflective holder 3200, and the second driving coil 212 may be disposed on the housing 1100.

The first driving magnet 111 may be disposed parallel to the first sensing magnet 121 on the rotational carrier 3300, and the second driving magnet 211 may be disposed parallel to the second sensing magnet 221 on the reflective holder 3200.

The first driving magnet 111 may be disposed on the same surface of the rotational carrier 3300 on which the first sensing magnet 121 is disposed, and the second driving magnet 211 may be disposed on the same surface of the reflective holder 3200 on which the second sensing magnet 221 is disposed.

The first driving magnet 111 may be disposed adjacent to or spaced apart from the first sensing magnet 121 on the rotational carrier 3300. Similarly, the second driving magnet 211 may be disposed adjacent to or spaced apart from the second sensing magnet 221 on the reflective holder 3200.

The positions of the first driving magnet 111 and the first sensing magnet 121 may be interchanged, and similarly, the positions of the second driving magnet 211 and the second sensing magnet 221 may be interchanged.

A polarity direction of the first driving magnet 111 and a polarity direction of the first sensing magnet 121 may be the same, and similarly, polarity directions of the second driving magnet 211 and the second sensing magnet 221 may also be the same.

The size of the first driving magnet 111 may be larger than that of the first sensing magnet 121, and similarly, the size of the second driving magnet 211 may be larger than that of the second sensing magnet 221.

The first and second driving magnets 111 and 211 may be arranged on a surface of the reflective module 3000 facing the housing 1100 in the third direction. Accordingly, the driving magnet, the driving coil, and the yoke may not be arranged in the second direction of the reflective module 3000 and the first direction of the reflective module 3000. Accordingly, the design difficulty may be reduced and the degree of freedom in arrangement may be increased.

In addition to being disposed parallel to the first and second sensing magnets 121 and 221 on one surface of the reflective module 3000, the driving magnet may also be arranged in plural on the other surface of the reflective module 3000 facing the housing 1100 in the third direction.

The housing 1100 may include a position sensor capable of detecting a movement amount of the sensing magnet. For example, the housing 1100 may include a first position sensor 122 facing the first sensing magnet 121. Similarly, the housing 1100 may include a second position sensor 222 facing the second sensing magnet 221.

When the incident surface 3110 of the reflective module 3000 and the upper surface of the housing 1100 are parallel, each position sensor may be disposed to face a neutral region of the sensing magnet. Here, the neutral region of the sensing magnet may refer to a boundary between two polarities (i.e., the N-pole and S-pole).

The reflective module 3000 may further include a yoke for magnetic flux concentration. For example, the yoke may be disposed to face the first driving coil 112 with the first driving magnet 111 interposed therebetween. The yoke may also be disposed to face the first sensing magnet 121.

However, the configuration of the driving unit driving the reflective module 3000 is not limited to that described above, and any structure capable of moving the reflective holder 3200 and the rotational carrier 3300 may be employed.

Hereinafter, the rotational carrier 3300 included in the reflective module 3000 will be described in more detail.

The reflective module 3000 may include the rotational carrier 3300, rotatable with respect to the housing 1100. The rotational carrier 3300 may rotate with respect to the housing 1100, while rotatably supporting the reflection holder 3200 and the reflective member 3100. For example, the rotational carrier 3300 is disposed to be rotatable about the first rotational axis, and thus, the reflective member 3100 may also rotate with the rotational carrier 3300 about the first rotational axis.

At least one ball member rotatably supporting the rotational carrier 3300 may be disposed between the rotational carrier 3300 and the housing 1100.

The at least one ball member may include a first ball member 3410 forming a rotational axis of the rotational carrier 3300 and a guide ball member 3420 facilitating stable rotation of the rotational carrier 3300.

The first ball member 3410 may form the first rotational axis by rotating in place, while being fixed in position with respect to the housing 1100. Accordingly, the first rotational axis may pass through the first ball member 3410.

The first rotational axis may approximately coincide with the first optical axis of the first lens module 2000 facing the reflective module 3000. Accordingly, an imaginary line extending along the first optical axis may pass through the first ball member 3410.

The first ball member 3410 may be accommodated in a first accommodation recess 1120 of the housing 1100. To secure the position of the first ball member 3410, the first accommodation recess 1120 may be configured to support the first ball member 3410 at at least three points. For example, the first accommodation recess 1120 may have at least three inclined surfaces, and the first ball member 3410 may be in point contact and supported by each inclined surface. Accordingly, the first ball member 3410 may be supported at at least three points by the first accommodation recess 1120. In addition, a recess facing the first accommodation recess 1120 and having the same shape may be disposed on the rotational carrier 3300. Accordingly, the first ball member 3410 may rotate in place, while being sandwiched between the rotational carrier 3300 and the housing 1100, thereby forming the first rotational axis.

At least one guide ball member 3420 may be disposed. For example, as illustrated in FIGS. 3 and 4, the reflective module 3000 may include a first ball member 3410 and two guide ball members 3420 spaced apart from each other. The guide ball members 3420 may move in a rolling manner with respect to the housing 1100 or the rotational carrier 3300 and may support the rotational carrier 3300 to rotate while maintaining a predetermined distance from a bottom surface of the housing 1100.

The guide ball member 3420 may be accommodated in a guide recess of the housing 1100. This guide recess is referred to as a first guide recess 1130. The guide ball member 3420 may be supported at two points or at one point in the first guide recess 1130. The guide ball member 3420 may be movable along the first guide recess 1130. The first guide recess 1130 may be disposed to extend in a circumferential direction of the first rotational axis. Alternatively, the first guide recess 1130 may be disposed to extend in a tangential direction of the circumference based on the first rotational axis.

Meanwhile, another guide recess accommodating the guide ball member 3420 may be disposed on a lower surface of the rotational carrier 3300. This guide recess is referred to as a second guide recess 2230. When the guide ball member 3420 is supported at two points on the first guide recess 1130, the guide ball member 3420 may be supported at one point on the second guide recess 2230, and when the guide ball member 3420 is supported at one point on the first guide recess 1130, the guide ball member may be supported at two points on the second guide recess 2230.

The guide ball member 3420 may support the rotational carrier 3300 by rolling while being sandwiched between the second guide recess 2230 of the rotational carrier 3300 and the first guide recess 1130 of the housing 1100.

Driving force for rotating the rotational carrier 3300 may be generated by a first driving unit 110. For example, the first driving unit 110 may include a first driving magnet 111 and a yoke disposed on the rotational carrier 3300, and a first driving coil 112 disposed on the housing 1100. Driving force may be generated by electromagnetic interaction between the first driving magnet 111 and the first driving coil 112.

The first driving magnet 111 and the first driving coil 112 may be disposed to face each other in the third direction. Here, the third direction may be perpendicular to both the first and second directions.

The first driving coil 112 may be disposed in the housing 1100. A plurality of first driving coils 112 may be disposed to face a plurality of driving magnets. Furthermore, the first driving coils 112 may be disposed to face the yoke with the first driving magnet 111 interposed therebetween.

The first driving magnet 111 may be configured such that a surface thereof facing the first driving coil 112 sequentially has an N-pole, a neutral region, and an S-pole in the rotational direction of the rotational carrier 3300.

The first driving unit 110 may include a yoke facing the first driving magnet 111. For example, as illustrated in FIGS. 3 and 4, the yoke may be disposed to face the first driving coil 112 with the first driving magnet 111 interposed therebetween.

The yoke may be configured as a magnetic member. Accordingly, the yoke may serve to focus magnetic field lines generated by the first driving magnet 111.

The first sensing unit 120 may include a first sensing magnet 121 and a first position sensor 122 detecting the position of the first sensing magnet 121. For example, the first position sensor 122 may include a Hall sensor as a magnetic sensor. The first position sensor 122 may detect a movement amount of the first sensing magnet 121 by detecting a change in magnetic flux passing through the first position sensor 122.

When one surface of the reflective module 3000 in the third direction and one surface of the housing 1100 are parallel, the first position sensor 122 may be disposed to face the neutral region of the first sensing magnet 121. That is, the first position sensor 122 may be disposed to face the boundary region between the N-pole and the S-pole of the first sensing magnet 121 to effectively detect the displacement of the first sensing magnet 121.

A plurality of first position sensors 122 may be arranged, and signals detected by each first position sensor 122 may be compared with each other to more precisely detect a change in the position of the first sensing magnet 121.

Magnetic members may be arranged between the rotational carrier 3300 and the housing 1100 and may interact to generate magnetic attraction. These are defined as third and fourth magnetic members 4510 and 4520, and magnetic force generated therebetween is defined as the first magnetic force.

The third magnetic member 4510 may be disposed on any one of the housing 1100 or the rotational carrier 3300, and the fourth magnetic member 4520 may be disposed on the other of the housing 1100 or the rotational carrier 3300.

At least one of the third magnetic member 4510 and the fourth magnetic member 4520 may be a pulling magnet, and both the third and fourth magnetic members 4510 and 4520 may be pulling magnets.

Hereinafter, the reflective holder 3200 included in the reflective module 3000 will be described in detail.

The reflective module 3000 may include the reflective holder 3200 rotatable with respect to the rotational carrier 3300. The reflective member 3100 may be secured to the reflective holder 3200 and may rotate with respect to the rotational carrier 3300. For example, the reflective holder 3200 may be disposed to be rotatable about the second rotational axis, and thus, the reflective member 3100 may also rotate about the second rotational axis together with the rotational carrier 3300.

The support portion 340 may be disposed between the reflective holder 3200 and the rotational carrier 3300 to guide the rotation of the reflective holder 3200.

In an embodiment, the support portion 340 may include a plurality of second ball members 3430. For example, as illustrated in FIG. 3, a plurality of second ball members 3430 may be arranged between the reflective holder 3200 and the rotational carrier 3300 to form the second rotational axis, which is a rotational axis of the reflective holder 3200.

The support portion 340 may include a plurality of second ball members 3430, which may be disposed spaced apart from each other in a direction perpendicular to the first rotational axis.

The support portion 340 may include a plurality of second ball members 3430, which may be spaced apart from each other in a direction perpendicular to both the first optical axis of the first lens module 2000 and the second optical axis of the second lens module 4000.

The support portion 340 may include a plurality of second ball members 3430, which may rotate in place, while being fixed in position with respect to the reflective holder 3200 or the rotational carrier 3300, thereby forming the second rotational axis. The second rotational axis may pass through the support portion 340.

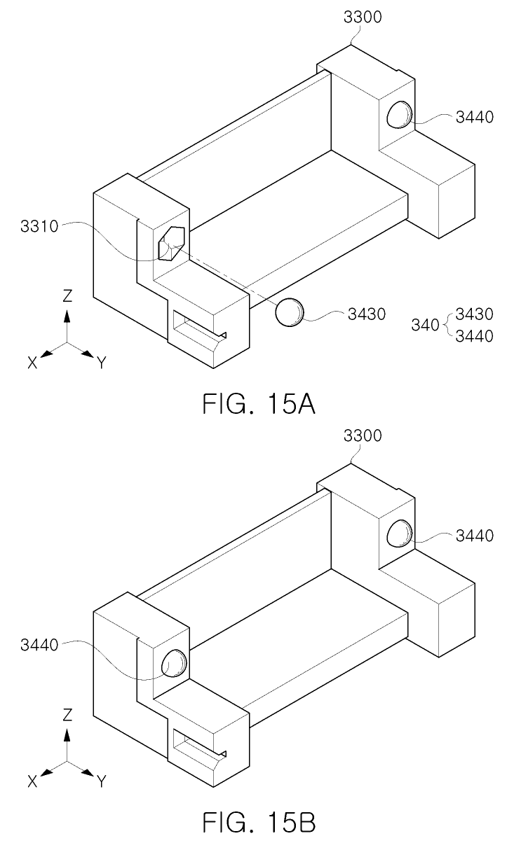

In another embodiment, the support portion 340 may include a support protrusion 3440, as illustrated in FIG. 15A and 15B. The support portion 340 may include one second ball member 3430 and one support protrusion 3440. In addition, the support portion 340 may include only a plurality of support protrusions 3440.

The support protrusion 3440 may have a different shape than the ball member. The support protrusion 3440 may protrude and have a curved shape or may have a hemispherical shape.

The reflective member 3100 may be disposed between the support portions 340. In this case, a plane extending from the reflective surface 3130 of the reflective member 3100 may pass through the second ball member 3430. However, the arrangement of the reflective member 3100 is not limited to the arrangement described above. For example, the reflective surface 3130 of the reflective member 3100 may be disposed to face at least one of the support portions 340.

The rotational carrier 3300 or the reflective holder 3200 may include a plurality of accommodation recesses capable of accommodating the support portion 340. For example, the rotational carrier 3300 may include a second accommodation recess 3310 disposed on a surface facing the reflective holder 3200 to accommodate a portion of the support portion 340. In addition, the reflective holder 3200 may include a third accommodation recess 3220 disposed on a surface facing the rotational carrier 3300 to accommodate another portion of the support portion 340. The second accommodation recess 3310 of the rotational carrier 3300 and the third accommodation recess 3220 of the reflective holder 3200 may be disposed to face each other in the second direction. Depending on the number of support portions 340, a plurality of second accommodation recesses 3310 and third accommodation recesses 3220 may be provided.

In an embodiment, to precisely align the relative positions of the reflective holder 3200 and the rotational carrier 3300, at least one of the plurality of second accommodation recesses 3310 and the plurality of third accommodation recesses 3220 may be configured to support the second ball member 3430 at at least three points. For example, at least one of the plurality of second accommodation recesses 3310 may be a recess having at least three inclined surfaces, and the other may be a recess having at least two inclined surfaces. The second ball member 3430 may be point-contact supported on each inclined surface. Accordingly, the second ball member 3430 may be supported at at least three points in the second accommodation recess 3310, having three inclined surfaces, and may be supported at two points in the second accommodation recess 3310, having two inclined surfaces. According to this support structure, the second ball member 3430 has a degree of freedom in one direction in one of the plurality of second accommodation recesses 3310, thereby overcoming tolerance-related defects.

In another embodiment, when the support portion 340 includes a support protrusion 3440 and the support protrusion 3440 is disposed in the rotational carrier 3300, the rotational carrier 3300 may not have an accommodation recess, and when the support protrusion 3440 is disposed on the rotational carrier. Similarly, if the support protrusion 3440 is disposed on the reflective holder 3200, the reflective holder 3200 may not have an accommodation recess.

Driving force for rotating the reflective holder 3200 may be generated by the second driving unit 210. For example, the second driving unit 210 may include a second driving magnet 211 disposed on the reflective holder 3200 and a second driving coil 212 disposed on the housing 1100. Driving force may be generated by electromagnetic interaction between the second driving magnet 211 and the second driving coil 212.

The second driving magnet 211 and the second driving coil 212 may be disposed to face each other in the third direction. This third direction may be perpendicular to both the first and second directions.

The second driving coil 212 may be disposed on the housing 1100. A plurality of second driving coils 212 may be disposed to face the plurality of driving magnets.

The second driving magnet 211 may be sequentially magnetized with different polarities in the rotational direction of the reflective holder 3200. For example, the second driving magnet 211 may be magnetized to have an N-pole, a neutral region, and an S-pole sequentially in the rotational direction of the reflective holder 3200.

The second sensing unit 220 may include a second position sensor 222 detecting the position of the second sensing magnet 221. For example, the second position sensor 222 may include a Hall sensor as a magnetic sensor. The second position sensor 222 may detect a movement amount of the second sensing magnet 221 by detecting a change in the magnetic flux passing through the second position sensor 222.

When one surface of the reflective module 3000 is parallel to one surface of the housing 1100 in the third direction, the second position sensor 222 may be disposed to face the neutral region of the second sensing magnet 221. That is, the second position sensor 222 may be disposed to face the boundary region between the N-pole and S-pole of the second sensing magnet 221, thereby effectively detecting the displacement of the second sensing magnet 221.

A plurality of second position sensors 222 may be arranged, and signals detected by each second position sensor 222 may be compared with each other to more precisely detect a change in the position of the second sensing magnet 221.

The reflective holder 3200 may be supported on the rotational carrier 3300 by a second magnetic force generated by a pair of magnetic members. The pair of magnetic members may include first and second magnetic members 3240 and 3340.

The first magnetic member 3240 may be disposed on one of the reflective holder 3200 or the rotational carrier 3300, and the second magnetic member 3340 may be disposed on the other of the reflective holder 3200 or the rotational carrier 3300.

At least one of the first magnetic member 3240 and the second magnetic member 3340 may be a pulling magnet, and both the first and second magnetic members 3240 and 3340 may be pulling magnets.

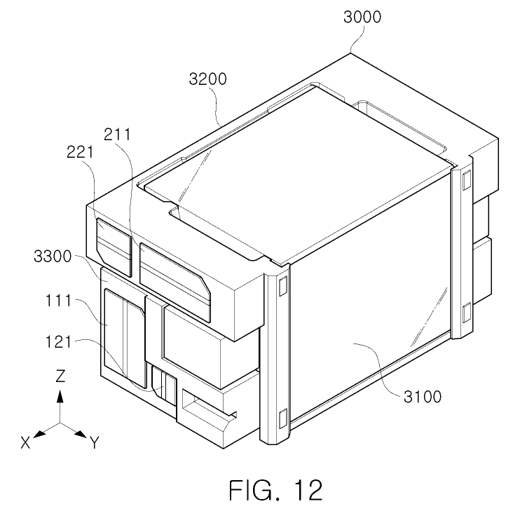

FIG. 12 is a diagram illustrating a structure of the reflective module 3000 according to a second embodiment of the present disclosure. The same description as that of the first embodiment given above with reference to FIGS. 3 to 11B will be omitted below.

The second driving unit 210 and the second sensing unit 220 may be disposed above so as to be away from a lower surface of the housing 1100 with respect to the first driving unit 110 and the first sensing unit 120 in the first direction.

The second driving magnet 211 and the second sensing magnet 221 may be disposed parallel to each other in the second direction.

The second driving magnet 211 and the second sensing magnet 221 may be disposed adjacent to or spaced apart from each other in the reflective holder 3200.

As the second driving magnet 211 and the second sensing magnet 221 are disposed to be away from the lower surface of the housing 1100 in the first direction with respect to the first driving magnet 111 and the first sensing magnet 121, the overall length of the reflective module 3000 in the first direction may be increased.

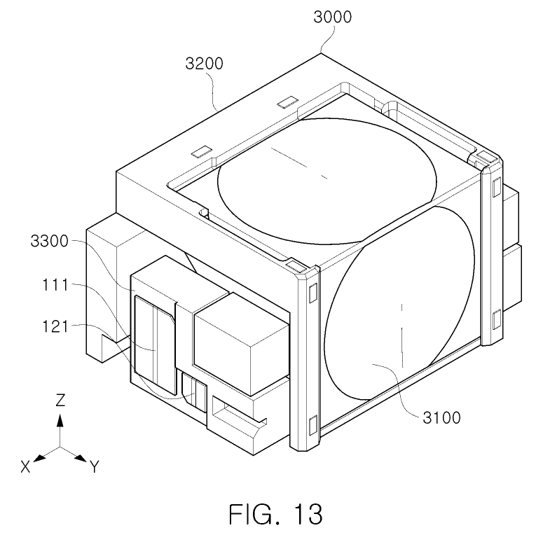

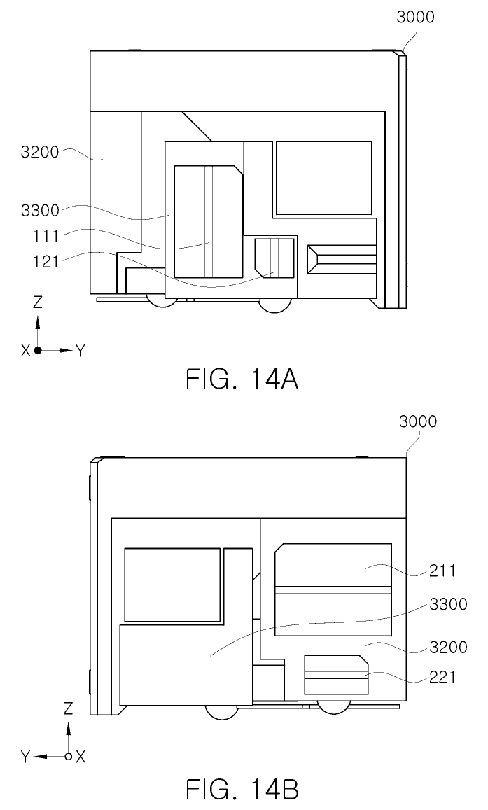

FIGS. 13, 14A and 14B are diagrams illustrating a structure of the reflective module 3000 according to a third embodiment of the present disclosure. The same description of the first embodiment given above with reference to FIGS. 3 to 11 will be omitted below.

Among the second driving units 210, only a single second driving magnet 211 may be disposed parallel to the second sensing magnet 221, which is not provided in plural. Similarly, only a single second driving coil 212 may be disposed to face the single second driving magnet 211, which is not provided in plural. Furthermore, among the first driving units 110, only a single first driving magnet 111 may be disposed parallel to the first sensing magnet 121, which is not provided in plural. Similarly, only a single first driving coil 112 may be disposed to face the single first driving magnet 111, which is not provided in plural. Accordingly, the overall size of the reflective module 3000 may be reduced.

The reflective module according to one or more embodiments of the present disclosure may improve external magnetic field interference.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflective module comprising:
a rotational carrier supported on a housing in a first direction, the rotational carrier being rotatable with respect to the housing;
a reflective holder supported on the rotational carrier in a second direction, different from the first direction, the reflective holder being rotatable with respect to the rotational carrier; and
a reflective member coupled to the reflective holder,
wherein a first sensing magnet disposed on the rotational carrier and a second sensing magnet disposed on the reflective holder face the housing in a third direction perpendicular to both the first direction and the second direction.

2. The reflective module of claim 1, further comprising:
first and second magnetic members configured to provide magnetic force so that the reflective holder is supported on the rotational carrier,
wherein the first magnetic member is disposed on either one of the reflective holder or the rotational carrier, and the second magnetic member is disposed on another of the reflective holder or the rotational carrier.

3. The reflective module of claim 2, wherein either one or both of the first magnetic member and the second magnetic member are pulling magnets.

4. The reflective module of claim 1, wherein the first sensing magnet is disposed facing a first position sensor disposed in the housing, and the second sensing magnet is disposed facing a second position sensor disposed in the housing.

5. The reflective module of claim 1, wherein
a first ball member, disposed between the rotational carrier and the housing, forms a rotational axis of the rotational carrier, and
a support portion, disposed between the reflective holder and the rotational carrier, forms a rotational axis of the reflective holder and comprises a plurality of second ball members.

6. The reflective module of claim 5, further comprising one or more accommodation recesses arranged in either one or both of the reflective holder and the rotational carrier, the one or more accommodation recesses being configured to accommodate the support portion in the second direction.

7. The reflective module of claim 5, wherein the rotational axis of the reflective holder passes through the support portion.

8. The reflective module of claim 5, wherein the support portion forming the rotational axis of the reflective holder further comprises one or more support protrusions.

9. The reflective module of claim 5, further comprising a first accommodation recess disposed in either one or both of the housing and the rotational carrier, the first accommodation recess being configured to support the first ball member at three or more contact points.

10. The reflective module of claim 9, further comprising:
a plurality of guide ball members configured to guide rotation of the rotational carrier,
wherein the plurality of guide ball members are movable in a direction perpendicular to the first direction with respect to the first ball member.

11. The reflective module of claim 1, further comprising a first driving magnet disposed on a surface of the rotational carrier facing the housing in the third direction, the first driving magnet being configured to provide driving force to rotate the rotational carrier.

12. The reflective module of claim 1, further comprising a second driving magnet disposed on a surface of the reflective holder facing the housing in the third direction, the second driving magnet configured to provide driving force to rotate the reflective holder.

13. A reflective module comprising:
a rotational carrier rotatable about a first rotational axis;
a reflective holder disposed on the rotational carrier, the reflective holder being rotatable about a second rotational axis perpendicular to the first rotational axis; and
a reflective member coupled to the reflective holder,
wherein a first sensing magnet is disposed on the rotational carrier, a second sensing magnet is disposed on the reflective holder, a first driving magnet is disposed parallel to the first sensing magnet on the rotational carrier, and a second driving magnet is disposed parallel to the second sensing magnet on the reflective holder.

14. The reflective module of claim 13, further comprising:
a housing;
wherein the rotational carrier is supported by the housing in a first direction, parallel to the first rotational axis, by first magnetic force; and
the reflective holder is supported by the rotational carrier in a second direction, perpendicular to the first direction, by second magnetic force.

15. The reflective module of claim 14, wherein
the first magnetic force is generated by a third magnetic member disposed in one of the housing and the rotational carrier, and a fourth magnetic member disposed in another of the housing and the rotational carrier, and
either one or both of the third magnetic member and the fourth magnetic member are pulling magnets.

16. The reflective module of claim 14, wherein
the second magnetic force is generated by a first magnetic member disposed on one of the rotational carrier and the reflective holder, and a second magnetic member disposed on the other of the rotational carrier and the reflective holder, and
either one or both of the first magnetic member and the second magnetic member are pulling magnets.

17. The reflective module of claim 13, further comprising:
a housing,
wherein the first and second sensing magnets are disposed to face a surface of the housing on an imaginary line extending through the second rotational axis.

18. The reflective module of claim 17, wherein the first sensing magnet is disposed facing a first position sensor disposed in the housing, and the second sensing magnet is disposed facing the second position sensor disposed in the housing.

19. The reflective module of claim 17, further comprising:
a first ball member, disposed between the rotational carrier and the housing, forming the first rotational axis; and
a support portion, disposed between the reflective holder and the rotational carrier, forming the second rotational axis, and comprising one or more second ball members.

20. The reflective module of claim 13, wherein polarity directions of the first sensing magnet and the first driving magnet are the same, and polarity directions of the second sensing magnet and the second driving magnet are the same.
